(19) United States
(12) Patent Application Publication
(10) Pub. No.: US 2025/0384770 A1
(43) Pub. Date: Dec. 18, 2025

(54) METHOD AND DEVICE FOR OPTIMIZED SCHEDULING OF MASSIVE TRANSPORT VEHICLES IN FLOOD DISASTERS

(71) Applicant: CHINA THREE GORGES UNIVERSITY, Yichang City (CN)

(72) Inventors: Changwen LI, Yichang City (CN); Haoxiong ZHAN, Yichang City (CN); Jiale HUANG, Yichang City (CN); Rui ZHOU, Yichang City (CN); Sujing LIN, Yichang City (CN); Liting YANG, Yichang City (CN); Feihan LI, Yichang City (CN); Zhiwei LI, Yichang City (CN); Jiaqi ZHU, Yichang City (CN); Jiarui LI, Yichang City (CN); Xiaolei LV, Yichang City (CN); Shuyun DU, Yichang City (CN)

(21) Appl. No.: 18/953,444

(22) Filed: Nov. 20, 2024

(30) Foreign Application Priority Data
Jun. 14, 2024 (CN) 202410772678.5

(51) Int. Cl. G08G 1/127; G01C 21/34; G06Q 50/26; G06Q 50/40

(52) U.S. Cl. CPC G08G 1/127; G01C 21/3415; G01C 21/3492; G06Q 50/265; G06Q 50/40

(57) ABSTRACT

A method and device for optimized scheduling of massive transport vehicles during flood disasters, relating to the field of transportation resource scheduling is provided. The method includes determining flood inundation ranges during various time periods of a flood based on watershed precipitation and river cross-section structural data and marking accessible roads within a flood-affected area with double truncation. A road information matrix and a resettlement zone information matrix is determined and model information and location information of transport vehicles within the flood-affected area are also determined. A transport vehicle dataset is also determined. With consideration of road emergencies, time-related variations of a road matrix, road collapse incidents, and mud-covered roads, a time-varying dynamic-planning traffic scheduling model is established with a goal of minimizing an arrival time of a last evacuated transport vehicle, and an optimal scheduling plan is determined to perform optimized scheduling on transport vehicles within the flood-affected area.

### CROSS REFERENCE TO RELATED APPLICATION

This patent application claims the benefit and priority of Chinese Patent Application No. 202410772678.5, filed with the China National Intellectual Property Administration on Jun. 14, 2024, the disclosure of which is incorporated by reference herein in its entirety as part of the present application.

### TECHNICAL FIELD

The present disclosure relates to the field of traffic resource scheduling, and in particular, to a method and device for optimized scheduling of massive transport vehicles during flood disasters.

### BACKGROUND

Under the combined influence of global climate change and high-intensity human activities, the frequency, intensity, duration, and scope of extreme rainfall have significantly increased. Extreme flood disasters have become more frequent and severe, resulting in a greater probability of “black swan” events that require swift evacuation of populations from high-risk areas. Existing flood forecasting models have become relatively mature and complete, with high accuracy in forecasting floods of major rivers, achieving a grade of B or above, and having a forecasting period of 7 to 15 days. However, forecasting flood disasters remains challenging, particularly in identifying personnel, vehicles, and resources within flooded areas and facilitating safe evacuation. Key issues include low utilization rates of transport vehicles for the evacuation of people and resources, the inability to consider and dynamically update road conditions affected by flooding, collapses, or traffic accidents in real-time, and a lack of comprehensive scientific scheduling schemes and path guidance for transport vehicles.

Furthermore, although existing path planning models or algorithms have point-to-point road planning solutions, especially with significant investments in big data by platforms like Amap, Tencent Maps, and Baidu Maps, which allow for real-time reporting of large-scale traffic congestion, there is currently no solution for the real-time guided scheduling of massive vehicles of various types during extreme flood disasters. The existing methods lack a balanced and comprehensive solution for state functions for traffic diversion before, during, and after disasters, resulting in slow model computation speeds and large cumulative errors, which can lead to missing critical transfer windows, failing to meet the requirements for immediate emergency evacuation.

To avoid severe economic losses and social risks associated with uncontrolled transfers of personnel, transport vehicles, and resources, the development and smart management of digital emergency evacuation plans will be an essential task in flood prevention and emergency operations. The core of the development and smart management of digital emergency evacuation plans lies in researching real-time optimization and intelligent scheduling technologies for flood disaster transportation resources.

### SUMMARY

An objective of the present disclosure is to provide a method and device for optimized scheduling of massive transport vehicles during flood disasters, to increase the efficiency of traffic resource optimization and scheduling in flood disasters.

To achieve the above objective, the present disclosure provides the following solutions.

According to a first aspect, the present disclosure provides a method for optimized scheduling of massive transport vehicles during flood disasters, including:
determining flood inundation ranges during various time periods of a flood based on watershed precipitation and river cross-section structural data using a MIKE model, a Muskingum model, and a two-dimensional hydrodynamic model, to obtain a time-varying vector map of a flood-affected area, where the flood-affected area includes an inundated region, a safe transfer region, and a flood edge transition region;
marking accessible roads within the flood-affected area with double truncation, determining a plurality of double-truncated segments, and determining a road information matrix and a resettlement zone information matrix based on the time-varying vector map of the flood-affected area, where the road information matrix includes: a segment junction status matrix, a segment length matrix, a segment width matrix, a segment traffic index matrix, and a segment grade matrix;
determining model information and location information of transport vehicles within the flood-affected area, and determining a transport vehicle dataset based on the model information of the transport vehicles, where the transport vehicle dataset includes a type, length, and width of each transport vehicle;
by applying a custom matrix criterion based on the road information matrix, the resettlement zone information matrix, the location information of transport vehicles within the flood-affected area, and the transport vehicle dataset, and considering time-related variations of a flooded road matrix, road emergencies, road collapse incidents, and areas of mud-covered roads, defining a vehicle driving direction as a specified forward direction and a reverse driving direction as a specified reverse direction, thus determining an update mode for a road time-varying matrix;
where the custom matrix criterion is defined as follows:
if i_{y}∈[nₖ′, nₖ₊₁′], then I_{y}=k, y being an incident number;
an update mode for the road time-varying matrix during a time-related variation of the flooded road matrix is as follows:

$$\{ \begin{matrix}∀ i ∈ [ {n}_{{I}_{1}}^{′} , {i}_{1} ] ⋂ [ {i}_{1} , {n}_{{I}_{i} + 1}^{′} ] , {a}_{i} ( t ) = 0 , & \begin{matrix}when the vehicle driving direction \\ is the specified forward direction\end{matrix} \\ ∀ i ∈ [ {n}_{{I}_{1} - 1}^{′} , {i}_{1} ] ⋂ [ {i}_{1} , {n}_{{I}_{i}}^{′} ] , {a}_{i} ( t ) = 0 , & \begin{matrix}when the vehicle driving direction \\ is the specified reverse direction\end{matrix}\end{matrix}$$

an update mode for the road time-varying matrix during a road emergency is as follows:

$$∀ i ∈ [ {n}_{{I}_{2}}^{′} , {i}_{2} ] , {W}_{i} ( t ) = {W}_{i} - {W}_{sudden} ;$$

an update mode for the road time-varying matrix during a road collapse incident is as follows:

$$\{ \begin{matrix}∀ i ∈ [ {n}_{{I}_{3}}^{′} , {i}_{3} ] , {a}_{i} ( t ) = 0 , & \begin{matrix}when the vehicle driving direction \\ is the specified forward direction\end{matrix} \\ ∀ i ∈ [ {i}_{3} , {n}_{{I}_{3}}^{′} ] , {a}_{i} ( t ) = 0 , & \begin{matrix}when the vehicle driving direction \\ is the specified reverse direction\end{matrix}\end{matrix} ;$$

an update mode for the road time-varying matrix when mud covers a road is as follows:

$$\{ \begin{matrix}∀ i ∈ [ {n}_{{I}_{4}}^{′} , {i}_{4} ] ⋂ [ {i}_{4} , {n}_{{I}_{4} + 1}^{′} ] , {a}_{i} ( t ) = 0 , & \begin{matrix}when the vehicle driving direction \\ is the specified forward direction\end{matrix} \\ ∀ i ∈ [ {n}_{{I}_{4} - 1}^{′} , {i}_{4} ] ⋂ [ i , {n}_{{I}_{4}}^{′} ] , , {a}_{i} ( t ) = 0 , & \begin{matrix}when the vehicle driving direction \\ is the specified reverse direction\end{matrix}\end{matrix} ;$$

where i represents a number of a double-truncated segment, nₖ′ represents a number of a starting double-truncated segment of a single-truncated road numbered k, I₁ represents a road area where a double-truncated segment numbered n_{I}_{₁}′ is located, represents a serial number of road area I₁, aᵢ(t) represents a traffic status index of the double-truncated segment numbered i at time t, I₂ represents a road area where a double-truncated segment numbered i₂ is located, n_{I}_{₂}′ represents a serial number of road area I₂, Wᵢ represents a width of the double-truncated segment numbered i, Wᵢ(t) represents a width of the double-truncated segment numbered i at time t, W_{sudden} represents a width reduction value of the double-truncated segment numbered i₂ at an accident location due to vehicle damage after an accident, I₃ represents a road area where a double-truncated segment numbered i₃ is located, n_{I}_{₃}′ represents a serial number of road area I₃, I₄ represents a road area of a double-truncated segment numbered i₄, and n_{I}_{₄}′ represents a serial number of road area I₄;
establishing a time-varying dynamic-planning traffic scheduling model, with a goal of minimizing an arrival time of a last evacuated transport vehicle and with an edge region traffic density, a total vehicle count in resettlement zones, and vehicle speeds on various roads as constraints; and
solving the time-varying dynamic-planning traffic scheduling model to determine an optimal scheduling plan, and optimizing scheduling of the transport vehicles within the flood-affected area based on the optimal scheduling plan.

According to a second aspect, the present disclosure provides a computer device, including a memory, a processor, and a computer program stored in the memory and executable on the processor, where the processor executes the computer program to implement the steps of the above method for optimized scheduling of massive transport vehicles during flood disasters.

According to specific examples provided in this application, this application discloses the following technical effects:

The present disclosure provides a method and device for optimized scheduling of massive transport vehicles during flood disasters. By marking accessible roads within a flood-affected area with double truncation, a plurality of double-truncated segments are determined. Based on a time-varying vector map of the flood-affected area, a road information matrix and a resettlement zone information matrix are determined. The road information matrix can encompass information about all roads, summarizing the conditions of all roads during extreme flooding. A segment traffic index matrix includes accessibility conditions of the majority of roads, reducing the computational pressure caused by complex indicator types. Moreover, during the determination of an optimal scheduling plan, factors such as road emergencies, time-related variations of a road matrix, road collapse incidents, and mud-covered roads are considered, enhancing the efficiency and accuracy of the generated optimal scheduling plan, thereby improving the efficiency of optimized scheduling of traffic resources during flood disasters.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a diagram illustrating an application environment of a method for optimized scheduling of massive transport vehicles in flood disasters according to an embodiment of the present disclosure;

FIG. 2 is a schematic flowchart of a method for optimized scheduling of massive transport vehicles during flood disasters according to an embodiment of the present disclosure;

FIG. 3 is a detailed architecture diagram of a method for optimized scheduling of massive transport vehicles during flood disasters according to an embodiment of the present disclosure;

FIG. 4 is a schematic diagram showing road segments and flooding conditions of an overall area.

FIG. 5 is a schematic diagram of an unexpected road accident;

FIG. 6 is a schematic diagram of a localized road collapse;

FIG. 7 is a schematic diagram illustrating effects of mud coverage; and

FIG. 8 is a schematic structural diagram of a computer device according to an embodiment of the present disclosure.

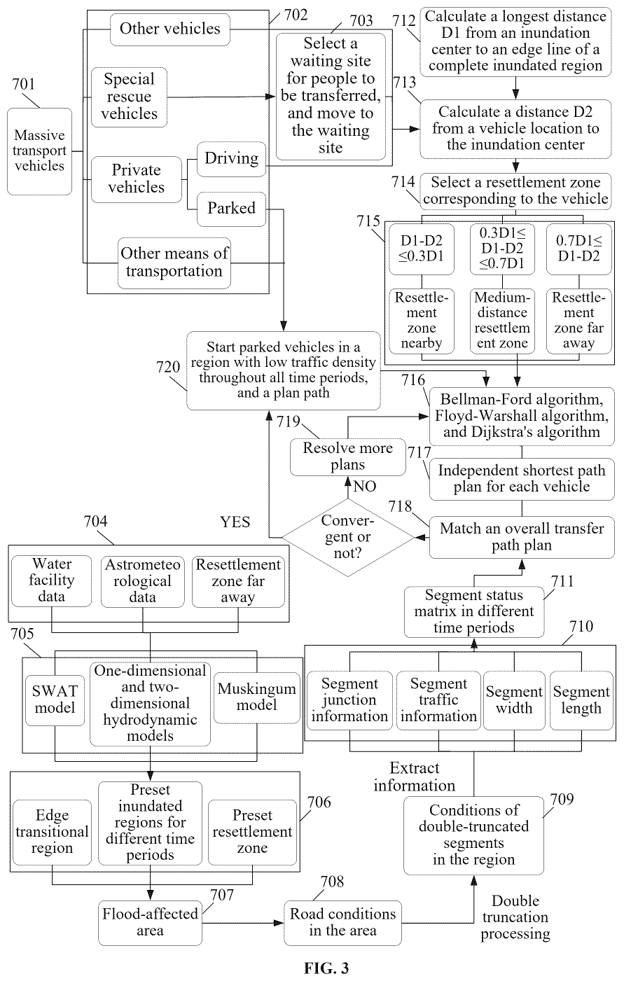

In FIG. 3:
701: Massive transport vehicles 702: Other vehicles, Special rescue vehicles, Private vehicles (driving, parked), Other
means of transportation
703: Select a waiting site for people to be transferred, and move to the waiting site
704: Water facility data, Astrometeorological data, Resettlement zone far away
705: SWAT model, One-dimensional and two-dimensional hydrodynamic models, Muskingum model
706: Edge transitional region, Preset inundated regions for different time periods, Preset resettlement zone
707: Flood-affected area
708: Road conditions in the area
709: Conditions of double-truncated segments in the region
710: Segment junction information; Segment traffic information; Segment width; Segment length
711: Segment status matrix in different time periods
712: Calculate a longest distance D1 from an inundation center to an edge line of a
complete inundated region
713: Calculate a distance D2 from a vehicle location to the inundation center
714: Select a resettlement zone corresponding to the vehicle
715: D1-D2≤0.3D1, Resettlement zone nearby; 0.3D1≤D1-D2≤0.7D1, Medium-distance resettlement zone; 0.7D1≤D1-D2, Resettlement zone far away
716: Bellman-Ford algorithm, Floyd-Warshall algorithm, and Dijkstra's algorithm
717: Independent shortest path plan for each vehicle
718: Match an overall transfer path plan
719: Resolve more plans
720: Start parked vehicles in a region with low traffic density throughout all time periods, and a plan path

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

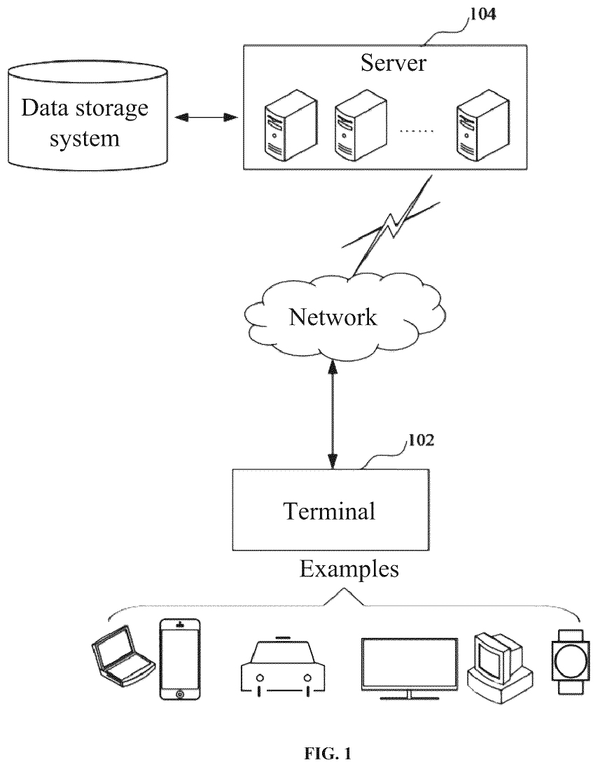

A method for optimized scheduling of massive transport vehicles in flood disasters provided by an embodiment of the present disclosure can be applied to the application environment as shown in FIG. 1. A terminal 102 communicates with a server 104 via a network. A data storage system can store data that the server 104 needs to process. The data storage system can be independently set up, integrated with the server 104, or placed in the cloud or on other servers. The terminal 102 can send to-be-processed road data and transport vehicle data to the server 104. After receiving the to-be-processed road data and transport vehicle data, the server 104 performs optimized scheduling on transport vehicles within a flood-affected area. The server 104 can feed back an obtained optimized scheduling plan to the terminal 102. Furthermore, in some embodiments, the method for optimized scheduling of massive transport vehicles in flood disasters can also be implemented solely by the server 104 or the terminal 102. For example, the terminal 102 can directly conduct optimized scheduling, or the server 104 can retrieve to-be-processed data from the data storage system for optimized scheduling.

The terminal 102 can be, but is not limited to, various desktop computers, laptops, smartphones, tablets, Internet of Things (IoT) devices, and portable wearable devices. The IoT device may be a smart speaker, a smart TV, a smart air conditioner, a smart in-vehicle device, or the like. The portable wearable device can be a smart watch, a smart band, a head-mounted device, or the like. The server 104 can be implemented using a standalone server, a server cluster consisting of a plurality of servers, or a cloud server.

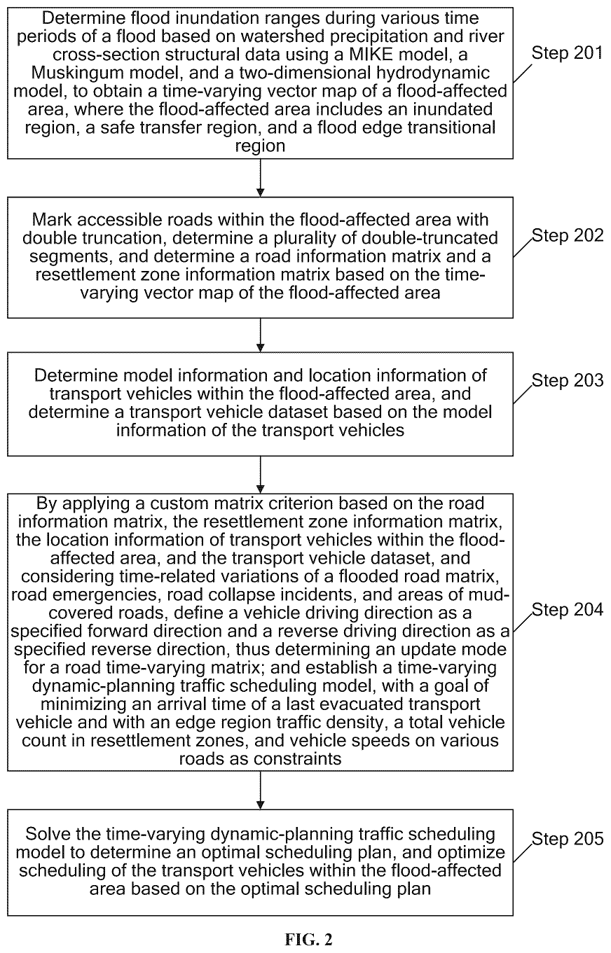

In an exemplary embodiment, as shown in FIG. 2 and FIG. 3, a method for optimized scheduling of massive transport vehicles in flood disasters is provided, which is executed by a computer device. Specifically, the method can be executed solely by a computer device such as a terminal or a server, or jointly by a terminal and a server. In the embodiment of the present disclosure, the method being applied to the server 104 in FIG. 1 is taken as an example for description, including step 201 to step 208 as follows:

Step 201: Determine flood inundation ranges during various time periods of a flood based on watershed precipitation and river cross-section structural data using a MIKE model, a Muskingum model, and a two-dimensional hydrodynamic model, to obtain a time-varying vector map of a flood-affected area. The flood-affected area includes an inundated region, a safe transfer region, and a flood edge transition region.

Specifically, the step 201 includes (11) to (13):

(11) Determine a vector map of an entire area based on the watershed precipitation and the river cross-section structural data, and rasterize the vector map of the entire area. The entire area refers to the flood-affected area.

Furthermore, in a Geographic Information System (GIS), a vector map of the entire area Sₐₗₗ, composed of the inundated region S_{flood} (impassable after flooding), safe transfer region Sᵣₑₛₑₜₜₗₑ (passable), and flood edge transition region S_{ordinary} (passable, and located between S_{flood} and resettle) is extracted in a grid-based manner, and is rasterized. The three types of zones are illustrated as follows:

$$\{ \begin{matrix}{S}_{flood} , region that will be fully inundated by flood eventually \\ {S}_{ordinary} , land region between inundated region and safe transfer region \\ {S}_{resettle} , complete region including all resettlement zones \\ {S}_{all} = {S}_{resettle} + {S}_{ordinary} + {S}_{flood}\end{matrix}$$

(12) Determine a flood inundation height hᵢ(t) at each moment for the entire area Sₐₗₗ based on the MIKE model, the Muskingum model, and the two-dimensional hydrodynamic model.

(13) For any given moment, update a grid area, of which a land height is less than the flood inundation height at the given moment, within the overall area to be an inundated region, resulting in the time-varying vector map of the flood-affected area.

That is, for the flood inundation status corresponding to time t, the maximum likelihood principle is used to mark the grid areas within the entire area Sₐₗₗ, of which the land heights are less than hᵢ(t) as updated S_{flood} (t), which are considered to be impassable.

Step 202: Mark accessible roads within the flood-affected area with double truncation, determine a plurality of double-truncated segments, and determine a road information matrix and a resettlement zone information matrix based on the time-varying vector map of the flood-affected area. The road information matrix includes a segment junction status matrix, a segment length matrix, a segment width matrix, a segment traffic index matrix, and a segment grade matrix.

Specifically, the step 202 includes (21) to (23):

(21) Truncate and mark the accessible roads within the flood-affected area at intersections to obtain a plurality of single-truncated roads.

As a specific implementation, the complete accessible roads are truncated and marked at any junction with three or more branches. An area between two marks constitutes a complete road section, resulting in a plurality of single-truncated roads to facilitate subsequent calculations.

(22) Perform length-based secondary truncation on each single-truncated road to obtain a plurality of double-truncated segments within each single-truncated road, and determine an association matrix of truncated road segments.

Specifically, for each single-line road after the first truncation, secondary truncation based on length is performed to form a double truncation vector map.

Segment information from the double truncation vector map is extracted. Assuming there are m single-truncated roads, which can be divided into n double-truncated segments, and numbers of double-truncated segments within the same single-truncated road are sequentially connected, an initial association matrix of truncated road segments is as follows:

$$N = [ {n}_{1} … {n}_{k} … {n}_{m} ] ;$$

where N represents the initial association matrix of truncated road segments, k represents a number of a single-truncated road, and nₖ represents a quantity of double-truncated segments in the single-truncated road numbered k.

Based on the initial association matrix of truncated road segments, the association matrix of truncated road segments is obtained:

$$\{ \begin{matrix}{n}_{k}^{′} = {\sum }_{{k}^{′} = 1}^{k} {n}_{{k}^{′}} \\ {N}^{′} = [ {n}_{1}^{′} … {n}_{k}^{′} … {n}_{m}^{′} ] ;\end{matrix}$$

where N′ represents the association matrix of truncated road segments, and nₖ′ represents a number of a starting double-truncated segment in the single-truncated road numbered k.

(23) Determine the road information matrix and the resettlement zone information matrix based on the time-varying vector map of the flood-affected area and the association matrix of truncated road segments.

1. Construct a segment junction status matrix, a segment length matrix, and a segment width matrix based on the association matrix of truncated road segments.

The segment junction status matrix includes a road junction status index for each double-truncated segment:

$$\{ \begin{matrix}F = [ {F}_{1} … {F}_{i} … {F}_{n} ] \\ {F}_{i} = \{ \begin{matrix}1 , & segment i is not located at road junction \\ n , & segment i is located at junction of road n\end{matrix}\end{matrix} ;$$

where F represents the segment junction status matrix, and Fᵢ represents a road junction status index of a double-truncated segment numbered i.

The segment length matrix includes a length of each double-truncated segment, while the segment width matrix includes a width of each double-truncated segment:

$$\{ \begin{matrix}L = {[ {L}_{1} … {L}_{i} … {L}_{n} ]}^{T} \\ W = {[ {W}_{1} … {W}_{i} … {W}_{n} ]}^{T}\end{matrix} ;$$

where L represents the segment length matrix, W represents the segment width matrix, Lᵢ represents a length of a double-truncated segment numbered i, and Wᵢ represents a width of the double-truncated segment numbered i.

2. Determine the segment traffic index matrix based on the time-varying vector map of the flood-affected area.

A time variable t is set, and a traffic status variable for the roads is introduced. The segment traffic index matrix includes a traffic status index of each double-truncated segment:

$$\{ \begin{matrix}{a}_{i} ( t ) ∈ [ 0 , 1 ] \\ {A}^{( t )} = {[ {a}_{1} ( t ) … {a}_{i} ( t ) … {a}_{n} ( t ) ]}^{T}\end{matrix} ;$$

where A₍ₜ₎ represents the segment traffic index matrix at time t, and aᵢ(t) represents a traffic status index for a double-truncated segment numbered i at time t.

3. Construct the segment grade matrix: The segment grade matrix includes a road grade of each double-truncated segment:

$$\{ \begin{matrix}{Le}_{i} = \{ \begin{matrix}1 , & segment i is highway \\ 2 , & segment i is grade 1 road \\ 3 , & segment i is grade 2 road \\ 4 , & segment i is grade 3 road \\ 5 , & segment i is grade 4 road\end{matrix} ; \\ Le = {[ {Le}_{1} … {Le}_{i} … {Le}_{n} ]}^{T}\end{matrix}$$

where Le represents the segment grade matrix, and Leᵢ represents a road grade of a double-truncated segment numbered i.

4. Construct the road information matrix G=[A^{(t)}, L, W, F, Le] based on the segment junction status matrix, the segment length matrix, the segment width matrix, the segment traffic index matrix, and the segment grade matrix.

5. Establish the resettlement zone information matrix based on the time-varying vector map of the flood-affected area.

All resettlement zones within the safe transfer region Sᵣₑₛₑₜₜₗₑ are obtained, and the resettlement zone information matrix is established, with a total of H resettlement zones. The resettlement zone information matrix includes, for each resettlement zone, a road information matrix of a segment where the resettlement zone is located, and a maximum vehicle capacity of the resettlement zone:

$$\{ \begin{matrix}{z}_{x} ∈ [ 1 , n ] , {z}_{x} ∈ N , x = 1 … H \\ {P}_{x} = [ {G}_{{z}_{x}} , {n}_{car} ( x ) ]\end{matrix} ;$$

where x represents a zone number of a resettlement zone, zₓ represents a number of a segment where the resettlement zone with zone number x is located, Pₓ represents an information matrix of the resettlement zone with zone number x, G_{z}_{ₓ} represents a road information matrix of the segment where the resettlement zone with zone number x is located, and n_{car}(x) represents a maximum vehicle capacity of the resettlement zone with zone number x.

In step 201 and step 202 of the present disclosure, based on foundational data such as the watershed precipitation and river cross-section structure, inundation ranges during various time periods of an extreme flood is calculated using a two-dimensional hydrodynamic model. Accessible roads in a predefined flood-affected area are marked with double truncation, obtaining a processed segment condition information matrix. Inundation statuses of the marked segments are updated according to the inundation ranges before, during, and after the disaster.

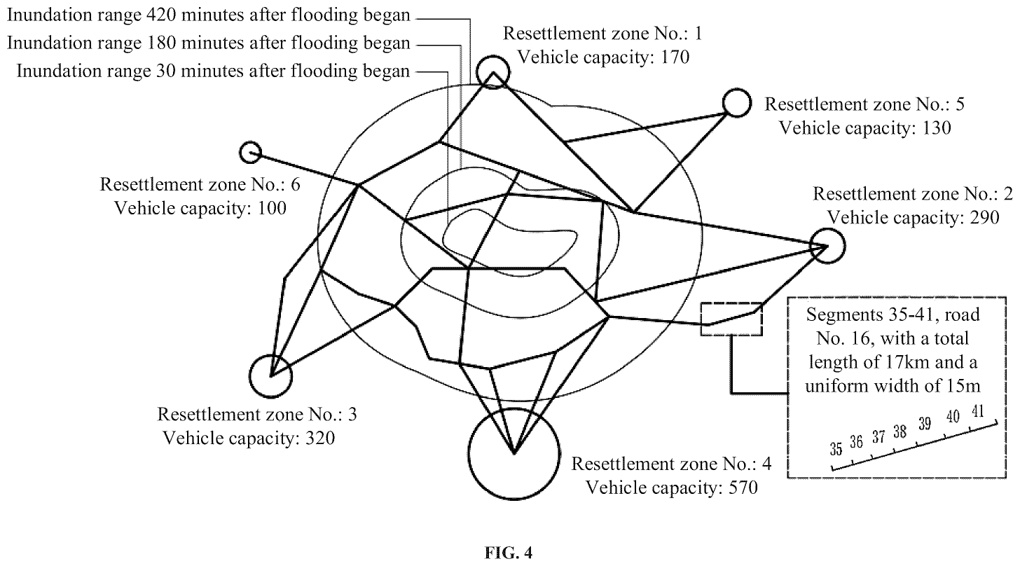

In the present disclosure, fundamental data such as precipitation and river cross-section structure in an extreme rainfall area is collected, and inundation ranges during various time periods of an extreme flood are calculated using a one-dimensional hydrodynamic model, a two-dimensional hydrodynamic model, and the Muskingum model. The accessible roads in the predefined flood-affected area marked with double truncation, delineating corresponding grid areas in the GIS, and extracting overall segment conditions of an entire area Sₐₗₗ composed of an inundated region S_{flood} a safe transfer region Sᵣₑₛₑₜₜₗₑ, and a flood edge transition region S_{ordinary} as illustrated in FIG. 4.

Road grade information (including width, segment length, and accessibility) is imported to obtain a processed segment condition information matrix. Inundation statuses of the marked segments are updated at five-minute intervals based on the inundation ranges before, during, and after the disaster. Some information about the double-truncated segments is shown in Table 1.

TABLE 1
Partial Information of Double-Truncated Segments

| | | Segment | Segment | | Quantity of | |
|---|---|---|---|---|---|---|
| Segment | Segment | width | length | Traffic | segment | Associated |
| No. | grade | (m) | (m) | index | junctions | road |
| 1 | 4 | 10 | 1030 | 0.11 | 2 | 1 |
| 2 | 4 | 10 | 1301 | 0.03 | 2 | 1 |
| . . . | . . . | . . . | . . . | . . . | . . . | . . . |
| 107 | 3 | 15 | 1270 | 0.05 | 2 | 23 |
| 108 | 3 | 15 | 971 | 0.02 | 2 | 23 |

The road information matrix constructed in the present disclosure can encompass information about all roads, summarizing the conditions of all roads during extreme floods. The traffic status index can cover accessibility conditions of the majority of roads, reducing the computational pressure caused by complex indicator types (for example, treating road collapses, traffic accidents, flooding, and mud coverage uniformly with the road traffic index).

Step 203: Determine model information and location information of transport vehicles within the flood-affected area, and determine a transport vehicle dataset based on the model information of the transport vehicles. The transport vehicle dataset includes a type, length, and width of each transport vehicle.

In the present disclosure, model information and location information of all transport vehicles available for evacuation (including railway transport vehicles, road transport vehicles, air transport vehicles, waterway transport vehicles, and other types of vehicles) are collected, and the collected information is processed through marking and classification to obtain the transport vehicle dataset.

Specifically, using vehicles as examples of transport vehicles, step 203 includes (31) to (34):

(31) Obtain model information and location information of available vehicles in the area through all available vehicle positioning methods (such as satellite positioning navigation, manufacturer tracking, regional monitoring scanning, reading information from parking lots in the area), where some information is stored as shown in Table 2. The available vehicles refer to vehicles that are either currently in operation or in a parked state but ready to operate normally.

TABLE 2
Partial Vehicle Information

| | | | No. of | |
|---|---|---|---|---|
| | | | associated | |
| Vehicle | Vehicle | Vehicle | double-truncated | Current |
| No. | type | model | segment | status |
| 1 | Private vehicle | 2 | 18 | Driving |
| 2 | Private vehicle | 1 | 19 | Driving |
| . . . | . . . | . . . | . . . | . . . |
| 1270 | Private vehicle | 1 | 35 | Parked |
| 1271 | Private vehicle | 1 | 39 | Parked |
| . . . | . . . | . . . | . . . | . . . |
| 1309 | Specialized | 1 | 47 | Parked |
| | rescue vehicle | | | |
| 1310 | Specialized | 1 | 47 | Parked |
| | rescue vehicle | | | |

(32) Mark available transport vehicles within S_{flood} (the inundated region), where a total quantity of available transport vehicles in S_{flood} is denoted as nₛ, and the transport vehicles are numbered j (j=1 . . . nₛ).

(33) Categorize each transport vehicle based on a length and a width thereof. In the present disclosure, based on Japan Road Transport Vehicle Law, available vehicles are classified into the following three types:

Type 1: vehicles with a length greater than 4.7m, a width greater than 1.7m, and using non-diesel engines with a displacement greater than 2000 cc.

Type 2: vehicles with a length ranging from 3.4m to 4.7m, a width ranging from 1.4m to 1.7m, and using non-diesel engines with a displacement ranging from 600 cc to 2000 cc.

Type 3: vehicles with a length less than 3.4m, a width less than 1.4m, and a total displacement below 600 cc.

For each available transport vehicle, a model is defined as, typeⱼ, with the following meanings:

$${type}_{j} = \{ \begin{matrix}1 , & vehicle j belongs to Type 1 \\ 2 , & vehicle j belongs to Type 2 \\ 3 , & vehicle j belongs to Type 3\end{matrix} .$$

(34) After the transport vehicles numbered j are classified into the three types as mentioned in (33), obtain vehicle body lengths and widths for the different types as follows:

$$\{ \begin{matrix}{carL}_{j} = 5.5 m , {carW}_{j} = 2. m , {type}_{j} = 1 \\ {carL}_{j} = 4.7 m , {carW}_{j} = 1.7 m , {type}_{j} = 2 \\ {carL}_{j} = 3.4 m , {carW}_{j} = 1.4 m , {type}_{j} = 3\end{matrix} ;$$

where typeⱼ represents a type of a transport vehicle numbered j, with 1, 2, and 3 indicating Type 1, Type 2, and Type 3, respectively; carLⱼ represents a length of the transport vehicle numbered j, and carWⱼ represents a width of the transport vehicle numbered j.

Step 204: By applying a custom matrix criterion based on the road information matrix, the resettlement zone information matrix, the location information of transport vehicles within the flood-affected area, and the transport vehicle dataset, and considering time-related variations of a flooded road matrix, road emergencies, road collapse incidents, and areas of mud-covered roads, define a vehicle driving direction as a specified forward direction and a reverse driving direction as a specified reverse direction, thus determining an update mode for a road time-varying matrix. A time-varying dynamic-planning traffic scheduling model is established, with a goal of minimizing an arrival time of a last evacuated transport vehicle and with an edge region traffic density, a total vehicle count in resettlement zones, and vehicle speeds on various roads as constraints.

The present disclosure proposes a real-time flood evacuation and optimized scheduling method for massive transport vehicles. It comprehensively considers factors like road emergencies during disasters, time-related variations in the flooded road matrix caused by extreme flooding, sudden traffic accidents, road collapse incidents, and post-disaster mud coverage incidents. With a goal of minimizing an arrival time of a last evacuated transport vehicle and with an edge region traffic density, a total vehicle count in resettlement zones, and vehicle speeds on various roads as constraints, the method ensures smooth transfers, determines optimal scheduling methods for different transport vehicles before and during disasters, with a focus on road transport vehicles, and makes an optimizing scheduling plan with a goal of minimizing the arrival time of the latest evacuated vehicle.

Specifically, the custom matrix criterion is defined as follows:

if i_{y}∈[nₖ′, nₖ₊₁′], then I_{y}=k, y being an incident number.

Step 204 includes (41) to (49) as follows:

(41) Calculate an ideal passing time for each transport vehicle in the flood-affected area.

1. Based on the GIS, extract a vector map of an extreme flood-affected area, construct a road information matrix, and extract a length Lᵢ and a width Wᵢ of a double-truncated segment numbered i, where a total capacity index for the double-truncated segment numbered i is Sᵢ=Lᵢ×Wᵢ.

2. Sum coverage indexes of available transport vehicles within an area of the double-truncated segment numbered i, resulting in a total available vehicle coverage index SC of the area as follows:

$$SC = {\sum }_{j = 1}^{n} {carL}_{j} \times {carW}_{j} .$$

3. Calculate a traffic density for each double-truncated segment based on the segment length matrix, the segment width matrix, and the transport vehicle dataset.

In an exemplary embodiment, the following formula is used to calculate the traffic density of the double-truncated segment numbered i:

$${ρ}_{i} ( t ) = \frac{{\sum }_{j = 1}^{J} {carL}_{j} \times {carW}_{j}}{{a}_{i} ( t ) \times {L}_{i} \times {W}_{i} ( t )} ;$$

where ρᵢ(t) represents a traffic density of a double-truncated segment numbered i at time t, J represents a total quantity of transport vehicles within the double-truncated segment numbered i, carLⱼ represents a length of the transport vehicle numbered j, carWⱼ represents a width of the transport vehicle numbered j, aᵢ(t) represents a traffic status index of the double-truncated segment numbered i at time t, Lᵢ represents a length of the double-truncated segment numbered i, and Wᵢ(t) represents a width of the double-truncated segment numbered i at time t.

Since MATLAB is employed for numerical testing in the present disclosure, when aᵢ(t) is 0, MATLAB automatically treats ρᵢ(t) as a maximum value to proceed with subsequent calculations normally. However, if another non-numerical computation programming software is used, it may be necessary to set a decision variable to a value ranging from infinitesimal to 1.

4. Calculate an intersection congestion correction coefficient for each double-truncated segment based on the segment junction status matrix.

Given that road intersections in the area involve factors such as vehicle turning and convergence, an intersection congestion correction coefficient needs to be incorporated for segments near road intersections in the area. In an exemplary embodiment, the intersection congestion correction coefficient for the double-truncated segment numbered i is calculated using the following formula:

$${ε}_{i} = {e}^{γ ( {F}_{imax} - {F}_{i} )} ;$$

where εᵢ represents an intersection congestion correction coefficient for a double-truncated segment numbered i, γ is a constant, Fᵢ represents a road junction status index for the double-truncated segment numbered i, and Fᵢₘₐₓ represents a maximum road junction status index for the double-truncated segments.

5. For any double-truncated segment and any transport vehicle, determine an ideal travel speed of the transport vehicle on the double-truncated segment at each moment based on the traffic density of the double-truncated segment, the intersection congestion correction coefficient of the double-truncated segment, and an ideal travel speed of the transport vehicle on the double-truncated segment.

In an exemplary embodiment, an ideal travel speed of the transport vehicle numbered j at time t on the double-truncated segment numbered i is determined using the following formula:

$${V}_{j}^{′ ( i )} ( t ) = {V}_{j}^{( i )} \times ( 1 - {e}^{α ( {ρ}_{i} ( t ) - β )} ) \times {ε}_{i} ;$$

where Vⱼ⁽ⁱ⁾′((t) represents the ideal travel speed of the transport vehicle numbered j on the double-truncated segment numbered i at time t, Vⱼ⁽ⁱ⁾ represents an ideal travel speed of the transport vehicle numbered j on the double-truncated segment numbered i, α represents a speed variation change coefficient, and β represents a speed variation correction coefficient.

6. Determine an ideal passing time of the transport vehicle on the double-truncated segment based on the ideal travel speed of the transport vehicle on the double-truncated segment at each moment and the segment length matrix.

In an exemplary embodiment, it is specified that for all available transport vehicles, the speed while traveling on the double-truncated segment numbered i is a real-time ideal travel speed, and thus the ideal passing time of transport vehicle numbered j on the double-truncated segment numbered i is determined using the following formula:

$${T}_{j}^{( i ) finish} = \frac{{V}_{j}^{′ ( i )} ( t )}{{L}_{i}} ;$$

where Tⱼ^{(i)finish} represents an ideal passing time of a transport vehicle numbered j on a double-truncated segment numbered i.

(42) Establish impact of road emergencies. Based on the segment width matrix and a road emergency, a width of the road after the emergency is determined.

1. When the flood inundates a double-truncated segment numbered i₁ at time t, access road area I₁ where the double-truncated segment numbered i₁ is located using a method as follows:

if i₁∈[nₖ, nₖ₊₁], then I₁=k.

2. Set an entire single-truncated road where the double-truncated segment numbered i₁ is located to an impassable state, that is:

$$\{ \begin{matrix}∀ i ∈ [ {{n}_{{I}_{1}}}^{′} , {i}_{1} ] ⋂ [ {i}_{1} , {{n}_{{I}_{1} + 1}}^{′} ] , & {a}_{i} ( t ) = 0 , & when the vehicle driving direction is the specified forward direction \\ ∀ i ∈ [ {{n}_{{I}_{1} - 1}}^{′} , {i}_{1} ] ⋂ [ {i}_{1} , {{n}_{{I}_{1}}}^{′} ] , & {a}_{i} ( t ) = 0 , & when the vehicle driving direction is the specified reverse direction\end{matrix} ;$$

where represents n_{I}_{₁}′ a number of assessed road area I₁.

(43) Update the segment traffic index matrix when a traffic accident occurs on any double-truncated segment.

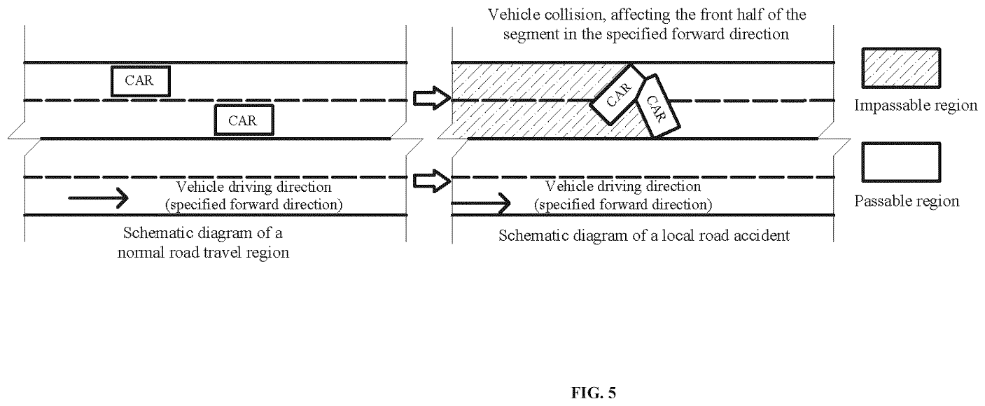

1. If a traffic accident occurs on a double-truncated segment numbered i₂ at time t, as shown in FIG. 5, first assess a road area I₂ where the double-truncated segment numbered i₂ is located using the following method: if i₂∈[nₖ′, nₖ₊₁′], then I₂=k.

2. Confirm a degree of road blockage caused by the traffic accident through satellite positioning, monitoring, and information from on-site personnel, and set a road blockage degree index as a width reduction value W_{sudden} of the double-truncated segment numbered i₂ at an accident location due to vehicle damage.

3. Define a vehicle driving direction as a specified forward direction and a reverse driving direction as a specified reverse direction, and based on the specified reverse direction, set a width of a preceding segment of the single-truncated road where the double-truncated segment numbered i₂ is located to a damaged state, that is:

$$∀ i ∈ [ {{n}_{{I}_{2}}}^{′} , {i}_{2} ] , {W}_{i} ( t ) = {W}_{i} - {W}_{sudden} ;$$

where n_{I}_{₂}′ represents a number of assessed road area I₂, and Wᵢ(t) represents a width of a double-truncated segment numbered i at time t.

(44) Update the segment traffic index matrix when a collapse incident occurs on any double-truncated segment.

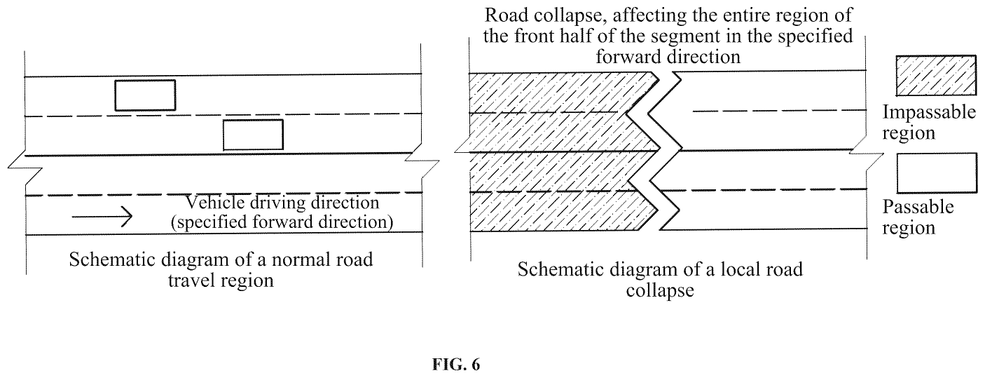

1. If a collapse incident occurs on a double-truncated segment numbered i₃ at time t, as shown in FIG. 6, first assess a road area I₃ where the double-truncated segment numbered i₃ is located using the following method: if i_{y}∈[nₖ′, nₖ₊₁′], then I₃=k.

2. Based on an opposite direction of traffic flow, set a width of a preceding segment of a single-truncated road where the double-truncated segment numbered i₃ is located to an impassable state, that is:

$$\{ \begin{matrix}∀ i ∈ [ {{n}_{{I}_{3}}}^{′} , {i}_{3} ] , & {a}_{i} ( t ) = 0 , & when the vehicle driving direction is the specified forward direction \\ ∀ i ∈ [ {i}_{3} , {{n}_{{I}_{3}}}^{′} ] , & {a}_{i} ( t ) = 0 , & when the vehicle driving direction is the specified reverse direction\end{matrix} ;$$

where n_{I}_{₃}′ represents a number of assessed road area I₃.

(45) Update the segment traffic index matrix when mud covers any double-truncated segment.

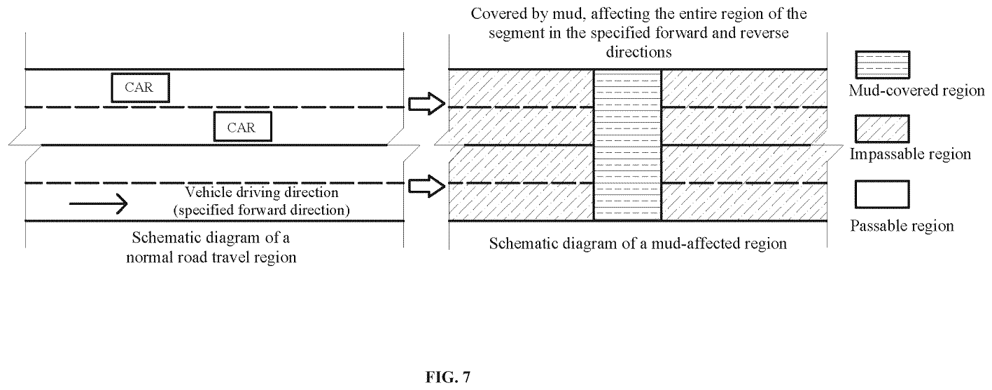

1. If a double-truncated segment numbered i₄ is covered by mud after the disaster at time t, as shown in FIG. 7, first assess a road area I₄ where the double-truncated segment numbered i₄ is located using the following method: if i₄[nₖ′, nₖ₊₁′], then I₄=k.

2. Set an entire single-truncated road where the double-truncated segment numbered i₄ is located to an impassable state, that is:

$$\{ \begin{matrix}∀ i ∈ [ {{n}_{{I}_{4}}}^{′} , {i}_{4} ] ⋂ [ {i}_{4} , {{n}_{{I}_{4} + 1}}^{′} ] , & {a}_{i} ( t ) = 0 , & when the vehicle driving direction is the specified forward direction \\ ∀ i ∈ [ {{n}_{{I}_{4} - 1}}^{′} , {i}_{4} ] ⋂ [ i , {{n}_{{I}_{4}}}^{′} ] , & {a}_{i} ( t ) = 0 , & when the vehicle driving direction is the specified reverse direction\end{matrix} ;$$

where n_{I}_{₄}′ represents a number of assessed road area I₄.

(46) Determine a traffic density constraint based on the traffic density of each double-truncated segment.

Specifically, based on a relationship between ideal travel speed and traffic density:

$${V}_{j}^{′ ( i )} ( t ) = {V}_{j}^{( i )} \times ( 1 - {e}^{α ( {ρ}_{i} ( t ) - β )} ) \times {ε}_{i} ,$$

the traffic density within the area of the double-truncated segment numbered i is constrained during a route planning process to ensure efficient traffic scheduling during major flood scenarios and to provide some scheduling time for handling emergencies, as well as road space for dealing with such emergencies. In this embodiment, the traffic density constraint is as follows:

$$\{ \begin{matrix}∀ t , ∀ i , & {ρ}_{i} ( t ) < \frac{1}{2} \\ ∀ t , ∀ i ∈ {S}_{ordinary} , & {ρ}_{i} ( t ) < \frac{1}{3}\end{matrix} .$$

(47) Determine a total vehicle count constraint for the resettlement zones based on the resettlement zone information matrix.

Specifically, for any resettlement zone among all H resettlement zones, the quantity of transport vehicles should not exceed 90% of a specified quantity for the resettlement zone:

$$∀ z , {n}_{z} ( t ) < 90 \% \times {n}_{car} ( z ) ;$$

where n_{z}(t) represents a quantity of transport vehicles in a resettlement zone numbered z at time t.

(48) Determine an ideal speed constraint based on the segment grade matrix and the transport vehicle dataset.

1. Road speed limits: In accordance with the “Urban Road Traffic Planning and Design Specifications,” “Urban Road Design Specifications,” and “Highway Engineering Technical Standards,” design speeds for various road levels are as follows:

$$∀ i , {V}_{min} ( {Le}_{i} ) \leq V ( {Le}_{i} ) \leq {V}_{max} ( {Le}_{i} ) ;$$

where vₘᵢₙ(Leᵢ) represents a minimum speed for transport vehicles on a double-truncated segment numbered i, v(Leᵢ) represents a speed for transport vehicles on the double-truncated segment numbered i, and vₘₐₓ(Leᵢ) represents a maximum speed for transport vehicles on the double-truncated segment numbered i.

2. For different models of transport vehicles, classify speeds for different vehicle models as follows:

$${V}_{{type}_{j} min}^{( i )} \leq {V}_{j}^{( i )} \leq {V}_{{type}_{j} max}^{( i )} , {type}_{j} = 1 , 2 , 3 ;$$

where

$${V}_{{type}_{j} min}^{( i )}$$

represents a minimum travel speed for a transport vehicle of type typeⱼ on a double-truncated segment numbered i, and

$${V}_{{type}_{j} max}^{( i )}$$

represents a maximum travel speed for the transport vehicle of type typeⱼ on the double-truncated segment numbered i.

3. Based on the above, obtain the ideal speed constraint for transport vehicles of type typeⱼ on the double-truncated segment numbered i as follows:

$$∀ i , MAX ( {V}_{{type}_{j} min}^{( i )} , {V}_{min} ( {Le}_{i} ) ) \leq {V}_{j}^{( i )} \leq MIN ( {V}_{{type}_{j} max}^{( i )} , {V}_{max} ( {Le}_{i} ) ) , \\ {type}_{j} = 1 , 2 , 3 ;$$

where MAX( ) indicates taking a maximum value from the parentheses, and MIN( ) indicates taking a minimum value from the parentheses.

(49) Based on the location information of the transport vehicles in the flood-affected area, the ideal passing time for the transport vehicles on each double-truncated segment, a post-emergency road width, the road information matrix, the traffic density constraint, the total vehicle count constraint for the resettlement zones, and the ideal speed constraint, establish the time-varying dynamic-planning traffic scheduling model with the goal of minimizing the arrival time of the last evacuated transport vehicle.

In an exemplary embodiment, an objective function of the time-varying dynamic-planning traffic scheduling model is:

$$f = min ( {\sum }_{i = 1}^{{n}_{k}} {T}_{j}^{( i ) finish} ) ;$$

where f represents a value of the objective function for the time-varying dynamic-planning traffic scheduling model, and nₖ represents a total quantity of double-truncated segments in a single-truncated road numbered k.

Step 205: Solve the time-varying dynamic-planning traffic scheduling model to determine an optimal scheduling plan, and optimize scheduling of the transport vehicles within the flood-affected area based on the optimal scheduling plan.

1. Based on the location information of the transport vehicles in the flood-affected area, determine a location of a transport vehicle numbered j within a double-truncated segment area numbered i.

2. Initially set a position of a core flood-affected region in the vector map as region S_{O}, and specify that a distance between region Sᵢ and region S_{O} is d_{Oi}. Vehicles in a is flood emergency evacuation region will move to resettlement sites closer to the flood-affected area, while vehicles in a flood peripheral region will move to resettlement sites farther from the flood-affected area. Vehicles in the flood emergency evacuation region are planned first, followed by the vehicles in the peripheral region, to ensure the overall safety of vehicle evacuation.

The flood emergency evacuation region is defined as region Sᵢ with d_{Oi}<0.5×MAX(d_{Oi}), while the flood peripheral region is defined as region S; with d_{Oi}>0.5×MAX(d_{Oi}).

In the present disclosure, the optimal scheduling plan is determined specifically through steps (51) to (55):

(51) Determine double-truncated segments iₛₜₐᵣₜ where all vehicles are located and double-truncated segments i_{end} where all resettlement zones are situated.

(52) Based on the Bellman-Ford algorithm, Floyd-Warshall algorithm, and Dijkstra's algorithm, obtain a iₛₜₐᵣₜ-to-i_{end} shortest distance path matrix roadⱼ⁽⁰⁾ for currently traveling vehicles and specialized rescue vehicles from the road information matrix G, for sequentially storing numbers of segments traversed in paths.

(53) In the road information matrix G, set a segment with a minimum d_{Oi} value in a shortest time path as impassable or in an extremely high traffic density state, to obtain G(l), and then obtain a iₛₜₐᵣₜ-to-i_{end} shortest time path matrix

$${road}_{j}^{( n )}$$

based on the Bellman-Ford algorithm.

(54) Repeat the above step (53) until obtaining a shortest time path matrix

$${road}_{j}^{( n )}$$

under state G(r) of the road information matrix, where r represents a quantity of paths obtained iteratively, with 3≤r≤7. This enhances subsequent calculation efficiency and flexibility of the plan.

(55) For all traveling vehicles that need to be transferred, apply the processing in steps (51) to (54), and find matching plans in the road information matrix, where a total quantity of different combinations of matching plans is assumed to be N_{can}, then for plan u (with u representing a plan number, where u=1, . . . N_{can}), the objective function represents a shortest evacuation duration for a vehicle that takes a longest time to evacuate among all evacuated vehicles in the plan, that is,

$$f = min ( {\sum }_{i = 1}^{{n}_{k}} {T}_{j}^{( i ) finish} )$$

Finally, an ideal scheduling plan for traveling transport vehicles in a major flood scenario is derived

Once the scheduling plan for the traveling vehicles is completed, transfer path options for parked transport vehicles within each parking area and for other transport vehicles are resolved based on the time-varying traffic density of each area, until a model solution convergence time exceeds a tolerable range or transfer path options for all transport vehicles in the area have been satisfactorily resolved.

Furthermore, road conditions are updated in real time based on drone observations or on-site surveys, and in case of various emergencies, the matrix is continuously updated in real time. New transfer paths will be resolved locally without affecting the overall transfer.

Given the numerous influencing factors considered in the present disclosure and the typically large data volume in practical use, iterative optimization algorithms such as genetic algorithms based on simulated annealing principles or particle swarm optimization algorithms based on fixed inertia weights can be used to solve the model, thereby reducing time complexity and enhancing the efficiency of generating optimal scheduling plans. Additionally, intelligent optimization algorithms such as random forests, support vector machines, or Back-Propagation (BP) neural networks can also be employed. It should be noted that regardless of the chosen method, it needs to be supported by fundamental devices meeting computation speed standards.

In an exemplary embodiment, resettlement zones are designated for currently traveling private vehicles. Partial selection status of the selected resettlement zones according to the present disclosure is shown in Table 3.

TABLE 3
Partial Selection Status of Resettlement Zones

| | | No. of | | Destination | Distance from | |
|---|---|---|---|---|---|---|
| | | associated | | resettlement | current location | |
| Vehicle | Vehicle | double-truncated | Current | zone | to resettlement | |
| No. | type | segment | status | No. | zone | |
| 1 | Private | 18 | Driving | 1 | 129 | km |
| | vehicle | | | | | |
| 2 | Private | 19 | Driving | 1 | 131 | km |
| | vehicle | | | | | |
| . . . | . . . | . . . | . . . | . . . | | |
| 890 | Private | 21 | Driving | 10 | 101 | km |
| | vehicle | | | | | |
| 891 | Private | 26 | Driving | 10 | 97 | km |

vehicle

Based on the Bellman-Ford algorithm, three or more transfer path options for each vehicle are computed and stored as shown in Table 4.

TABLE 4
Individual Transfer Path Options for Private Vehicles

| | Vehicle | |
|---|---|---|
| Vehicle | plan | Transfer |
| No. | No. | plan |
| 1 | 1 | 18 (current location)-19-20-21- . . . -78-79- |
| | | Resettlement zone No. 1 |
| | 2 | 18 (current location)-19-[31]-[32]- . . . -78-79- |
| | | Resettlement zone No. 1 |
| . . . | . . . | . . . |
| 891 | 3 | 26 (current location)-27-28-29- . . . -53- |
| | | 52- . . . -106-107-Resettlement zone No. 10 |
| | 4 | 26 (current location)-27-28-29- . . . -[8]- |
| | | [9]- . . . -106-107-Resettlement zone No. 10 |

Ultimately, the initial transfer plans obtained through the optimization algorithm are shown in Table 5.

TABLE 5
Initial Transfer Path Plans for All Private Vehicles

| | Vehicle | |
|---|---|---|
| | selected | |
| Vehicle | plan | Transfer |
| No. | No. | plan |
| 1 | 2 | 18 (current location)-19-31-32- . . . -78-79- |
| | | Resettlement zone No. 1 |
| 2 | 1 | 19 (current location)-31-32- . . . -78-79- |
| | | Resettlement zone No. 1 |
| . . . | . . . | . . . |
| 891 | 3 | 26 (current location)-27-28-29- . . . -53- |
| | | 52- . . . -106-107-Resettlement zone No. 10 |

In the present disclosure, the flooding conditions are analyzed, and the marked segment inundation status is updated based on the inundation range of each time period. Vehicle information within the area is collected, classified, and marked with sequence numbers. Based on the inundation segment map for each time period and the initial vehicle position maps, analysis diagrams of traffic flow for each segment from the start of vehicle evacuation to the completion of evacuation under an assumed plan, as well as planning path diagrams for each numbered vehicle are constructed. Optimal transfer routes for each vehicle under the premise of reduced accessible roads in flooding and the impact of road traffic on speed. Finally, based on the optimal transfer route plans for each vehicle, scheduling of all numbered vehicles within the area is optimized. The present disclosure considers the cumulative impact of vehicle conditions at various stages of flood prevention on subsequent transfers and returns, as well as congestion issues for different types of transport and resettlement zones, thereby improving the efficiency of real-time flood evacuation and optimized scheduling for massive transport vehicles in the context of extreme flooding disasters.

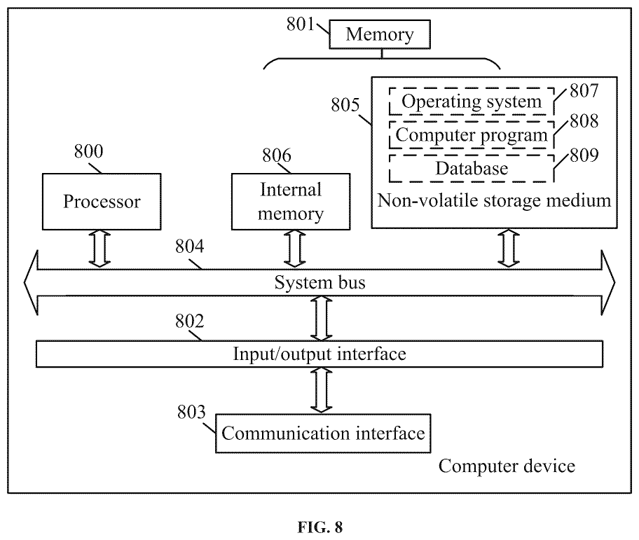

In an exemplary embodiment, a computer device is provided. The computer device may be a server or a terminal, and an internal structure thereof may be as shown in FIG. 8. The computer device includes a processor 800, a memory 801, an input/output (I/O) interface 802 and a communication interface 803. The processor 800, the memory 801 and the I/O interface 802 are connected through a system bus 804. The communication interface 803 is connected to the system bus 804 through the I/O interface 802. The processor 800 of the computer device is configured to provide computing and control capabilities. The memory 801 of the computer device includes a non-volatile storage medium and an internal memory 806. The non-volatile storage medium stores an operating system 807, a computer program 808, and a database 809. The internal memory 806 provides an environment for operation of the operating system 807 and the computer program 808 in the non-volatile storage medium. The database 809 of the computer device is configured to store related data for optimized scheduling of massive transport vehicles during flood disasters. The I/O interface 802 of the computer device is configured to exchange information between the processor 800 and an external device. The communication interface 803 of the computer device is configured to communicate with an external terminal through a network. The computer program 808, when executed by the processor, 800 implements a method for optimized scheduling of massive transport vehicles in flood disasters.

Those skilled in the art may understand that the structure shown in FIG. 8 is only a block diagram of a part of the structure related to the solutions of the present disclosure and does not constitute a limitation on a computer device to which the solutions of the present disclosure are applied. Specifically, the computer device may include more or fewer components than those shown in the figure, or combine some components, or have different component arrangements.

In an exemplary embodiment, a computer device is provided, including a memory and a processor, where the memory stores a computer program, and the computer program is executed by the processor to implement the steps of the above method embodiment.

In an exemplary embodiment, a computer-readable storage medium is provided. The computer-readable storage medium stores a computer program, and the computer program is executed by a processor to implement the steps of the above method embodiment.

In an exemplary embodiment, a computer program product is provided. The computer program product includes a computer program, and the computer program is executed by a processor to implement the steps of the above method embodiment.

It is to be noted that information of a user (including but not limited to device information of the user, personal information of the user and the like) and data (including but not limited to data for analysis, data for storage, data for exhibition and the like) in the present disclosure are information and data authorized by the user or fully authorized by each party, and relevant data shall be acquired, used and processed according to related regulations.

Those of ordinary skill in the art may understand that all or some of the procedures in the methods of the above embodiments may be implemented by a computer program instructing related hardware. The computer program may be stored in a non-volatile computer-readable storage medium. When the computer program is executed, the procedures in the embodiments of the above methods may be performed. Any reference to a memory, a database, or other media used in the embodiments of the present disclosure may include a non-volatile and/or volatile memory. The non-volatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general-purpose processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A method for optimized scheduling of massive transport vehicles during flood disasters, comprising:
determining flood inundation ranges during various time periods of a flood based on watershed precipitation and river cross-section structural data using a MIKE model, a Muskingum model, and a two-dimensional hydrodynamic model, to obtain a time-varying vector map of a flood-affected area, wherein the flood-affected area comprises an inundated region, a safe transfer region, and a flood edge transition region;
marking accessible roads within the flood-affected area with double truncation, determining a plurality of double-truncated segments, and determining a road information matrix and a resettlement zone information matrix based on the time-varying vector map of the flood-affected area, wherein the road information matrix comprises: a segment junction status matrix, a segment length matrix, a segment width matrix, a segment traffic index matrix, and a segment grade matrix;
determining model information and location information of transport vehicles within the flood-affected area, and determining a transport vehicle dataset based on the model information of the transport vehicles, wherein the transport vehicle dataset comprises a type, length, and width of each transport vehicle;
by applying a custom matrix criterion based on the road information matrix, the resettlement zone information matrix, the location information of transport vehicles within the flood-affected area, and the transport vehicle dataset, and considering time-related variations of a flooded road matrix, road emergencies, road collapse incidents, and areas of mud-covered roads, defining a vehicle driving direction as a specified forward direction and a reverse driving direction as a specified reverse direction, thus determining an update mode for a road time-varying matrix;
wherein the custom matrix criterion is defined as follows:
if i_{y}∈[nₖ′, nₖ₊₁′], then I_{y}=k, y being an incident number;
an update mode for the road time-varying matrix during a time-related variation of the flooded road matrix is as follows:
$$\{ \begin{matrix}∀ i ∈ [ {n}_{{I}_{1}}^{′} , {i}_{1} ] ⋂ [ {i}_{1} , {n}_{{I}_{1} + 1}^{′} ] , & {a}_{i} ( t ) = 0 , & \begin{matrix}when the vehicle driving \\ \begin{matrix}direction is the specified \\ forward direction\end{matrix}\end{matrix} \\ ∀ i ∈ [ {n}_{{I}_{1} - 1}^{′} , {i}_{1} ] ⋂ [ {i}_{1} , {n}_{{I}_{1}}^{′} ] , & {a}_{i} ( t ) = 0 , & \begin{matrix}\begin{matrix}when the vehicle driving \\ direction is the specified\end{matrix} \\ reverse direction\end{matrix}\end{matrix} ;$$
an update mode for the road time-varying matrix during a road emergency is as follows:
$$∀ i ∈ [ {n}_{{I}_{2}}^{′} , {i}_{2} ] , {W}_{i} ( t ) = {W}_{i} - {W}_{sudden} ;$$
an update mode for the road time-varying matrix during a road collapse incident is as follows:
$$\{ \begin{matrix}∀ i ∈ [ {n}_{{I}_{3}}^{′} , {i}_{3} ] , & {a}_{i} ( t ) = 0 , & \begin{matrix}when the vehicle driving direction \\ is the specified forward direction\end{matrix} \\ ∀ i ∈ [ {i}_{3} , {n}_{{I}_{3}}^{′} ] , & {a}_{i} ( t ) = 0 , & \begin{matrix}when the vehicle driving direction \\ is the specified reverse direction\end{matrix}\end{matrix} ;$$
an update mode for the road time-varying matrix when mud covers a road is as follows:
$$\{ \begin{matrix}∀ i ∈ [ {n}_{{I}_{4}}^{′} , {i}_{4} ] ⋂ [ {i}_{4} , {n}_{{I}_{4} + 1}^{′} ] , & {a}_{i} ( t ) = 0 , & \begin{matrix}when the vehicle driving \\ \begin{matrix}direction is the specified \\ forward direction\end{matrix}\end{matrix} \\ ∀ i ∈ [ {n}_{{I}_{4} - 1}^{′} , {i}_{4} ] ⋂ [ i , {n}_{{I}_{4}}^{′} ] , & {a}_{i} ( t ) = 0 , & \begin{matrix}\begin{matrix}when the vehicle driving \\ direction is the specified\end{matrix} \\ reverse direction\end{matrix}\end{matrix} ;$$
wherein i represents a number of a double-truncated segment, nₖ′ represents a number of a starting double-truncated segment of a single-truncated road numbered k, I₁ represents a road area where a double-truncated segment numbered i₁ is located, n_{I}_{₁}′ represents a serial number of road area I₁, aᵢ(t) represents a traffic status index of the double-truncated segment numbered i at time t, I₂ represents a road area where a double-truncated segment numbered i₂ is located, n_{I}_{₂}′ represents a serial number of road area I₂, Wᵢ represents a width of the double-truncated segment numbered i, Wᵢ(t) represents a width of the double-truncated segment numbered i at time t, W_{sudden} represents a width reduction value of the double-truncated segment numbered i₂ at an accident location due to vehicle damage after an accident, I₃ represents a road area where a double-truncated segment numbered i₃ is located, n_{I}_{₃}′ represents a serial number of road area, I₃, I₄ represents a road area of a double-truncated segment numbered i₄, and n_{I}_{₄}′ represents a serial number of road area I₄;
establishing a time-varying dynamic-planning traffic scheduling model, with a goal of minimizing an arrival time of a last evacuated transport vehicle and with an edge region traffic density, a total vehicle count in resettlement zones, and vehicle speeds on various roads as constraints; and
solving the time-varying dynamic-planning traffic scheduling model to determine an optimal scheduling plan, and optimizing scheduling of the transport vehicles within the flood-affected area based on the optimal scheduling plan.

2. The method for optimized scheduling of massive transport vehicles during flood disasters according to claim 1, wherein said determining the flood inundation ranges during various time periods of the flood based on the watershed precipitation and the river cross-section structural data using the MIKE model, the Muskingum model, and the two-dimensional hydrodynamic model, to obtain the time-varying vector map of the flood-affected area specifically comprises:
determining a vector map of an entire area based on the watershed precipitation and the river cross-section structural data, and rasterizing the vector map of the entire area;
determining a flood inundation height at each moment for the entire area based on the MIKE model, the Muskingum model, and the two-dimensional hydrodynamic model; and
for any given moment, updating a grid area, of which a land height is less than the flood inundation height at the given moment, within the overall area to be an inundated region, resulting in the time-varying vector map of the flood-affected area.

3. The method for optimized scheduling of massive transport vehicles during flood disasters according to claim 1, wherein the flood-affected area is Sₐₗₗ=Sᵣₑₛₑₜₜₗₑ+S_{ordinary}+S_{flood}; Sₐₗₗ represents the flood-affected area, Sᵣₑₛₑₜₜₗₑ represents the safe transfer region, S_{ordinary} represents the flood edge transition region, and S_{flood} represents the inundated region;
said marking the accessible roads within the flood-affected area with double truncation, determining the plurality of double-truncated segments, and determining the road information matrix and the resettlement zone information matrix based on the time-varying vector map of the flood-affected area specifically comprises:
truncating and marking the accessible roads within the flood-affected area at intersections to obtain a plurality of single-truncated roads;
performing length-based secondary truncation on each single-truncated road to obtain a plurality of double-truncated segments within each single-truncated road, and determining an association matrix of truncated road segments:
$${N}^{′} = [ {n}_{1}^{′} … {n}_{k}^{′} … {n}_{m}^{′} ] , {n}_{k}^{′} = {\sum }_{{k}^{′} = 1}^{k} {n}_{{k}^{′}} ,$$
wherein N′ represents the association matrix of truncated road segments, m represents a quantity of single-truncated roads, and k represents a number of the single-truncated road; and
determining the road information matrix and the resettlement zone information matrix based on the time-varying vector map of the flood-affected area and the association matrix of truncated road segments.

4. The method for optimized scheduling of massive transport vehicles during flood disasters according to claim 3, wherein said determining the road information matrix and the resettlement zone information matrix based on the time-varying vector map of the flood-affected area and the association matrix of truncated road segments specifically comprises:
constructing a segment junction status matrix, a segment length matrix, and a segment width matrix based on the association matrix of truncated road segments, wherein the segment junction status matrix comprises a road junction status index for each double-truncated segment: F=[F₁ . . . Fᵢ . . . Fₙ], Fᵢ∈{1, 2, . . . , n}; the segment length matrix comprises a length of each double-truncated segment: L=[L₁ . . . Lᵢ . . . Lₙ]^{T}; the segment width matrix comprises a width of each double-truncated segment: W=[W₁ . . . Wᵢ . . . Wₙ]^{T}; F represents the segment junction status matrix; Fᵢ represents a road junction status index of a double-truncated segment numbered i; n represents a quantity of double-truncated segments; L represents the segment length matrix, W represents the segment width matrix, Lᵢ represents a length of a double-truncated segment numbered i, and Wᵢ represents a width of the double-truncated segment numbered i;
determining the segment traffic index matrix based on the time-varying vector map of the flood-affected area, wherein the segment traffic index matrix A^{(t)}=[a₁(t) . . . aᵢ(t) . . . aₙ(t)]^{T} comprises a traffic status index of each double-truncated segment: aᵢ(t)∈[0,1] and A^{(t)} represents the segment traffic index matrix at time t;
constructing the segment grade matrix Le=[Le₁ . . . Leᵢ . . . Leₙ]^{T}, wherein the segment grade matrix comprises a road grade of each double-truncated segment: Leᵢ∈{1, 2, 3, 4, 5}, Le represents the segment grade matrix, and Leᵢ represents a road grade of a double-truncated segment numbered i;
constructing the road information matrix G=[A^{(t)}, L, W, F, Le] based on the segment junction status matrix, the segment length matrix, the segment width matrix, the segment traffic index matrix, and the segment grade matrix, wherein G represents the road information matrix; and
establishing the resettlement zone information matrix Pₓ=[G_{z}_{ₓ}, n_{car}(x)], x=1 . . . H based on the time-varying vector map of the flood-affected area, wherein the resettlement zone information matrix Pₓ comprises, for each resettlement zone, a road information matrix G_{z}_{ₓ} of a segment where the resettlement zone is located, and a maximum vehicle capacity of the resettlement zone: n_{car}(x); H represents a quantity of the resettlement zones, x represents a zone number of a resettlement zone, zₓ represents a number of a segment where the resettlement zone with zone number x is located, Pₓ represents an information matrix of the resettlement zone with zone number x, G_{z}_{ₓ} represents a road information matrix of the segment where the resettlement zone with zone number x is located, and n_{car}(x) represents a maximum vehicle capacity of the resettlement zone with zone number x.

5. The method for optimized scheduling of massive transport vehicles during flood disasters according to claim 1, wherein said establishing the time-varying dynamic-planning traffic scheduling model, with the goal of minimizing the arrival time of the last evacuated transport vehicle and with the edge region traffic density, the total vehicle count in the resettlement zones, and the vehicle speeds on various roads as constraints specifically comprises:
calculating a traffic density for each double-truncated segment based on the segment length matrix, the segment width matrix, and the transport vehicle dataset;
calculating an intersection congestion correction coefficient for each double-truncated segment based on the segment junction status matrix;
for any double-truncated segment and any transport vehicle, determining an ideal travel speed of the transport vehicle on the double-truncated segment at each moment based on the traffic density of the double-truncated segment, the intersection congestion correction coefficient of the double-truncated segment, and an ideal travel speed of the transport vehicle on the double-truncated segment;
determining an ideal passing time of the transport vehicle on the double-truncated segment based on the ideal travel speed of the transport vehicle on the double-truncated segment at each moment and the segment length matrix;
determining a traffic density constraint
$$\{ \begin{matrix}∀ t , ∀ i , {ρ}_{i} ( t ) < \frac{1}{2} \\ ∀ t , ∀ i ∈ {S}_{ordinary} , {ρ}_{i} ( t ) < \frac{1}{3}\end{matrix}$$
based on the traffic density of each double-truncated segment, wherein ρᵢ(t) represents a traffic density of a double-truncated segment numbered i at time t, and S_{ordinary} represents the flood edge transition region;
determining a total vehicle count constraint for the resettlement zones ∀z,n_{z}(t)<90%×n_{car}(z) based on the resettlement zone information matrix, wherein n_{z}(t) represents a quantity of transport vehicles in a resettlement zone numbered z at time t, and n_{car}(x) represents a maximum vehicle capacity of the resettlement zone numbered z;
determining an ideal speed constraint
$$∀ i , MAX ( {V}_{{type}_{j} min}^{( i )} , {V}_{min} ( {Le}_{i} ) ) \leq {V}_{j}^{( i )} \leq MIN ( {V}_{{type}_{j} max}^{( i )} , {V}_{max} ( {Le}_{i} ) ) ,$$
$${type}_{j} = 1 , 2 , 3$$
based on the segment grade matrix and the transport vehicle dataset, wherein
$${V}_{{type}_{j} min}^{( i )}$$
represents a minimum travel speed for a transport vehicle of type typeⱼ on a double-truncated segment numbered i,
$${V}_{{type}_{j} max}^{( i )}$$
represents a maximum travel speed for the transport vehicle of type typeⱼ on the double-truncated segment numbered i, vₘᵢₙ(Leᵢ) represents a minimum speed for transport vehicles on the double-truncated segment numbered i, Vₘₐₓ(Leᵢ) represents a maximum speed for transport vehicles on the double-truncated segment numbered i, and Vⱼ⁽ⁱ⁾ represents an ideal travel speed for a transport vehicle numbered j on the double-truncated segment numbered i; and
based on the location information of the transport vehicles in the flood-affected area, the ideal passing time for the transport vehicles on each double-truncated segment, a post-emergency road width, the road information matrix, the traffic density constraint, the total vehicle count constraint for the resettlement zones, and the ideal speed constraint, establishing the time-varying dynamic-planning traffic scheduling model with the goal of minimizing the arrival time of the last evacuated transport vehicle.

6. The method for optimized scheduling of massive transport vehicles during flood disasters according to claim 5, wherein a traffic density and an intersection congestion correction coefficient for the double-truncated segment numbered i are calculated using the following formula:
$${ρ}_{i} ( t ) = \frac{{\sum }_{j = 1}^{J} {carL}_{j} \times {carW}_{j}}{{a}_{i} ( t ) \times {L}_{i} \times {W}_{i} ( t )} ;$$
$${ε}_{i} = {e}^{γ ( {F}_{i max} - {F}_{i} )}$$
wherein J represents a total quantity of transport vehicles within the double-truncated segment numbered i, carLⱼ represents a length of the transport vehicle numbered j, carWⱼ represents a width of the transport vehicle numbered j, Lᵢ represents a length of the double-truncated segment numbered i, εᵢ represents the intersection congestion correction coefficient for the double-truncated segment numbered i, γ is a constant, Fᵢ represents a road junction status index of the double-truncated segment numbered i, and Fᵢₘₐₓ represents a maximum road junction status index for the double-truncated segments.

7. The method for optimized scheduling of massive transport vehicles during flood disasters according to claim 5, wherein an ideal travel speed of the transport vehicle numbered j at time t on the double-truncated segment numbered i is determined using the following formula:
$${V}_{j}^{′ ( i )} ( t ) = {V}_{j}^{( i )} \times ( 1 - {e}^{α ( {ρ}_{i} ( t ) - β )} ) \times {ε}_{i} ;$$
wherein
$${V}_{j}^{′ ( i )} ( t )$$
represents the ideal travel speed of the transport vehicle numbered j on the double-truncated segment numbered i at time t, ρᵢ(t) represents a traffic density of the double-truncated segment numbered i at time t, εᵢ represents the intersection congestion correction coefficient for the double-truncated segment numbered i, α represents a speed variation change coefficient, and β represents a speed variation correction coefficient.

8. The method for optimized scheduling of massive transport vehicles during flood disasters according to claim 5, wherein an ideal passing time of the transport vehicle numbered j on the double-truncated segment numbered i is determined using the following formula:
$${T}_{j}^{( i ) finish} = \frac{{V}_{j}^{′ ( i )} ( t )}{{L}_{i}} ;$$
wherein
$${T}_{j}^{( i ) finish}$$
represents the ideal passing time of the transport vehicle numbered j on the double-truncated segment numbered i,
$${V}_{j}^{′ ( i )} ( t )$$
represents an ideal travel speed of the transport vehicle numbered j on the double-truncated segment numbered i at time t, and Lᵢ represents a length of the double-truncated segment numbered i.

9. The method for optimized scheduling of massive transport vehicles during flood disasters according to claim 8, wherein an objective function of the time-varying dynamic-planning traffic scheduling model is:
$$f = min ( {\sum }_{i = 1}^{{n}_{k}} {T}_{j}^{( i ) finish} ) ;$$
wherein f represents a value of the objective function for the time-varying dynamic-planning traffic scheduling model, and nₖ represents a total quantity of double-truncated segments in a single-truncated road numbered k.

10. A computer device, comprising a memory, a processor, and a computer program stored in the memory and executable on the processor, wherein the processor executes the computer program to perform the steps of the method for optimized scheduling of massive transport vehicles during flood disasters according to claim 1.

11. The computer device according to claim 10, wherein said determining the flood inundation ranges during various time periods of the flood based on the watershed precipitation and the river cross-section structural data using the MIKE model, the Muskingum model, and the two-dimensional hydrodynamic model, to obtain the time-varying vector map of the flood-affected area specifically comprises:
determining a vector map of an entire area based on the watershed precipitation and the river cross-section structural data, and rasterizing the vector map of the entire area;
determining a flood inundation height at each moment for the entire area based on the MIKE model, the Muskingum model, and the two-dimensional hydrodynamic model; and
for any given moment, updating a grid area, of which a land height is less than the flood inundation height at the given moment, within the overall area to be an inundated region, resulting in the time-varying vector map of the flood-affected area.

12. The computer device according to claim 10, wherein the flood-affected area is Sₐₗₗ=Sᵣₑₛₑₜₜₗₑ+S_{ordinary}+S_{flood}; Sₐₗₗ represents the flood-affected area, Sᵣₑₛₑₜₜₗₑ represents the safe transfer region, S_{ordinary} represents the flood edge transition region, and S_{flood} represents the inundated region;
said marking the accessible roads within the flood-affected area with double truncation, determining the plurality of double-truncated segments, and determining the road information matrix and the resettlement zone information matrix based on the time-varying vector map of the flood-affected area specifically comprises:
truncating and marking the accessible roads within the flood-affected area at intersections to obtain a plurality of single-truncated roads;
performing length-based secondary truncation on each single-truncated road to obtain a plurality of double-truncated segments within each single-truncated road, and determining an association matrix of truncated road segments:
$${N}^{′} = [ {n}_{1}^{′} ⋯ {n}_{k}^{′} ⋯ {n}_{m}^{′} ] , {n}_{k}^{′} = {\sum }_{k = 1}^{k} {n}_{k}^{′} ,$$
wherein N′ represents the association matrix of truncated road segments, m represents a quantity of single-truncated roads, and k represents a number of the single-truncated road; and
determining the road information matrix and the resettlement zone information matrix based on the time-varying vector map of the flood-affected area and the association matrix of truncated road segments.

13. The computer device according to claim 12, wherein said determining the road information matrix and the resettlement zone information matrix based on the time-varying vector map of the flood-affected area and the association matrix of truncated road segments specifically comprises:
constructing a segment junction status matrix, a segment length matrix, and a segment width matrix based on the association matrix of truncated road segments, wherein the segment junction status matrix comprises a road junction status index for each double-truncated segment: F=[F₁ . . . Fᵢ . . . Fₙ], Fᵢ∈{1, 2, . . . , n}; the segment length matrix comprises a length of each double-truncated segment: L=[L₁ . . . Lᵢ . . . Lₙ]^{T}; the segment width matrix comprises a width of each double-truncated segment: W=[W₁ . . . Wᵢ . . . Wₙ]^{T}; F represents the segment junction status matrix; Fᵢ represents a road junction status index of a double-truncated segment numbered i; n represents a quantity of double-truncated segments; L represents the segment length matrix, W represents the segment width matrix, Lᵢ represents a length of a double-truncated segment numbered i, and Wᵢ represents a width of the double-truncated segment numbered i;
determining the segment traffic index matrix based on the time-varying vector map of the flood-affected area, wherein the segment traffic index matrix A^{(t)}=[a₁(t) . . . aᵢ(t) . . . aₙ(t)]^{T} comprises a traffic status index of each double-truncated segment: aᵢ(t)∈[0,1], and A^{(t)} represents the segment traffic index matrix at time t;
constructing the segment grade matrix Le=[Le₁ . . . Leᵢ . . . Leₙ]^{T}, wherein the segment grade matrix comprises a road grade of each double-truncated segment: Leᵢ∈{1, 2, 3, 4, 5}, Le represents the segment grade matrix, and Leᵢ represents a road grade of a double-truncated segment numbered i;
constructing the road information matrix G=[A^{(t)}, L, W, F, Le] based on the segment junction status matrix, the segment length matrix, the segment width matrix, the segment traffic index matrix, and the segment grade matrix, wherein G represents the road information matrix; and
establishing the resettlement zone information matrix Pₓ=[G_{z}_{ₓ}, n_{car}(x)], x=1 . . . H based on the time-varying vector map of the flood-affected area, wherein the resettlement zone information matrix Pₓ comprises, for each resettlement zone, a road information matrix G_{z}_{ₓ} of a segment where the resettlement zone is located, and a maximum vehicle capacity of the resettlement zone: n_{car}(x); H represents a quantity of the resettlement zones, x represents a zone number of a resettlement zone, zₓ represents a number of a segment where the resettlement zone with zone number x is located, Pₓ represents an information matrix of the resettlement zone with zone number x, G_{z}_{ₓ} represents a road information matrix of the segment where the resettlement zone with zone number x is located, and n_{car}(x) represents a maximum vehicle capacity of the resettlement zone with zone number x.

14. The computer device according to claim 10, wherein said establishing the time-varying dynamic-planning traffic scheduling model, with the goal of minimizing the arrival time of the last evacuated transport vehicle and with the edge region traffic density, the total vehicle count in the resettlement zones, and the vehicle speeds on various roads as constraints specifically comprises:
calculating a traffic density for each double-truncated segment based on the segment length matrix, the segment width matrix, and the transport vehicle dataset;
calculating an intersection congestion correction coefficient for each double-truncated segment based on the segment junction status matrix;
for any double-truncated segment and any transport vehicle, determining an ideal travel speed of the transport vehicle on the double-truncated segment at each moment based on the traffic density of the double-truncated segment, the intersection congestion correction coefficient of the double-truncated segment, and an ideal travel speed of the transport vehicle on the double-truncated segment;
determining an ideal passing time of the transport vehicle on the double-truncated segment based on the ideal travel speed of the transport vehicle on the double-truncated segment at each moment and the segment length matrix;
determining a traffic density constraint
$$\{ \begin{matrix}∀ t , ∀ i , & {ρ}_{i} ( t ) < \frac{1}{2} \\ ∀ t , ∀ i ∈ {S}_{ordinary} , & {ρ}_{i} ( t ) < \frac{1}{3}\end{matrix}$$
based on the traffic density of each double-truncated segment, wherein ρᵢ(t) represents a traffic density of a double-truncated segment numbered i at time t, and S_{ordinary} represents the flood edge transition region;
determining a total vehicle count constraint for the resettlement zones ∀z,n_{z}(t)<90%×n_{car}(z) based on the resettlement zone information matrix, wherein n_{z}(t) represents a quantity of transport vehicles in a resettlement zone numbered z at time t, and n_{car}(x) represents a maximum vehicle capacity of the resettlement zone numbered z;
determining an ideal speed constraint
$$∀ i , MAX ( {V}_{{type}_{j} min}^{( i )} , {V}_{min} ( {Le}_{i} ) ) \leq {V}_{j}^{( i )} \leq MIN ( {V}_{{type}_{j} max}^{( i )} , {V}_{max} ( {Le}_{i} ) ) , {type}_{j} = 1 , 2 , 3$$
based on the segment grade matrix and the transport vehicle dataset, wherein
$${V}_{{type}_{j} min}^{( i )}$$
represents a minimum travel speed for a transport vehicle of type typeⱼ on a double-truncated segment numbered i,
$${V}_{{type}_{j} max}^{( i )}$$
represents a maximum travel speed for the transport vehicle of type typeⱼ on the double-truncated segment numbered i, vₘᵢₙ(Leᵢ) represents a minimum speed for transport vehicles on the double-truncated segment numbered i, vₘₐₓ(Leᵢ) represents a maximum speed for transport vehicles on the double-truncated segment numbered i, and Vⱼ⁽ⁱ⁾ represents an ideal travel speed for a transport vehicle numbered j on the double-truncated segment numbered i; and
based on the location information of the transport vehicles in the flood-affected area, the ideal passing time for the transport vehicles on each double-truncated segment, a post-emergency road width, the road information matrix, the traffic density constraint, the total vehicle count constraint for the resettlement zones, and the ideal speed constraint, establishing the time-varying dynamic-planning traffic scheduling model with the goal of minimizing the arrival time of the last evacuated transport vehicle.

15. The computer device according to claim 14, wherein a traffic density and an intersection congestion correction coefficient for the double-truncated segment numbered i are calculated using the following formula:
$${ρ}_{i} ( t ) = \frac{{\sum }_{j = 1}^{J} {carL}_{j} \times {carW}_{j}}{{a}_{i} ( t ) \times {L}_{i} \times {W}_{i} ( t )}$$
$${ε}_{i} = {e}^{γ ( {F}_{imax} - {F}_{i} )} ;$$
wherein J represents a total quantity of transport vehicles within the double-truncated segment numbered i, carLⱼ represents a length of the transport vehicle numbered j, carWⱼ represents a width of the transport vehicle numbered j, Lᵢ represents a length of the double-truncated segment numbered i, εᵢ represents the intersection congestion correction coefficient for the double-truncated segment numbered i, γ is a constant, Fᵢ represents a road junction status index of the double-truncated segment numbered i, and Fᵢₘₐₓ represents a maximum road junction status index for the double-truncated segments.

16. The computer device according to claim 14, wherein an ideal travel speed of the transport vehicle numbered j at time t on the double-truncated segment numbered i is determined using the following formula:
$${V}_{j}^{′ ( i )} ( t ) = {V}_{j}^{( i )} \times ( 1 - {e}^{α ( {ρ}_{i} ( t ) - β )} ) \times {ε}_{i} ;$$
wherein Vⱼ⁽ⁱ⁾′(t) represents the ideal travel speed of the transport vehicle numbered j on the double-truncated segment numbered i at time t, ρᵢ(t) represents a traffic density of the double-truncated segment numbered i at time t, εᵢ represents the intersection congestion correction coefficient for the double-truncated segment numbered i, α represents a speed variation change coefficient, and β represents a speed variation correction coefficient.

17. The computer device according to claim 14, wherein an ideal passing time of the transport vehicle numbered j on the double-truncated segment numbered i is determined using the following formula:
$${T}_{j}^{( i ) finish} = \frac{{V}_{j}^{′ ( i )} ( t )}{{L}_{i}} ;$$
wherein
$${T}_{j}^{( i ) finish}$$
represents the ideal passing time of the transport vehicle numbered j on the double-truncated segment numbered i,
$${V}_{j}^{′ ( i )} ( t )$$
represents an ideal travel speed of the transport vehicle numbered j on the double-truncated segment numbered i at time t, and Lᵢ represents a length of the double-truncated segment numbered i.

18. The computer device according to claim 17, wherein an objective function of the time-varying dynamic-planning traffic scheduling model is:
$$f = min ( {\sum }_{i = 1}^{{n}_{k}} {T}_{j}^{( i ) finish} ) ;$$
wherein f represents a value of the objective function for the time-varying dynamic-planning traffic scheduling model, and nₖ represents a total quantity of double-truncated segments in a single-truncated road numbered k.
